(19) United States
(12) Patent Application Publication
(10) Pub. No.: US 2007/0132203 A1
(43) Pub. Date: Jun. 14, 2007

(54) Height adjusting device for a bike seat

(76) Inventor: Cozy Junya Yamakoshi, Camarillo, CA (US)

Correspondence Address: BACON & THOMAS, PLLC, 625 SLATERS LANE, FOURTH FLOOR, ALEXANDRIA, VA, 22314, US

(21) Appl. No.: 11/302,266

(22) Filed: Dec. 14, 2005

(51) Int. Cl. B62J 1/00

(52) U.S. Cl. 280/288.4; 297/215.13

(57) ABSTRACT

A height adjusting device for a bike seat includes a seat tube, a fixing base, a seat post, a movable block, two bolts, plural plastic ornamental sleeves and a twinkling light. The seat tube is shaped as a water drop in its cross-sectional view. The fixing base shaped the same as the seat tube is to be fitted in and welded with the seat tube and provided with a tube hole and a sliding slot in communication with the tube hole. The movable block is screwed with two bolts able to keep the movable block suspended and moved back and forth, enabling the movable block to loosen or squeeze the seat post.

### BACKGROUND OF THE INVENTION

1. Field of the Invention

This invention relates to a height adjusting device for a bike seat, particularly to one using bolts to relax the seat post for adjusting the height and to squeeze the seat post for keeping it positioned.

2. Description of the Prior Art

A conventional height adjusting device for a bike seat is commonly to form an axial crevice at the top of a seat tube. Two projected ears are respectively welded beside the crevice and bored with a hole respectively for a bolt to pass through and to screw with a nut tightly or loosely to keep the crevice narrowed or broadened, enabling a seat post to adjust its height and to be positioned. But the crevice and the ears are easy to be broken down, absolutely losing their functions.

### SUMMARY OF THE INVENTION

The prime object of this invention is to offer a height-adjusting device for a bike seat.

The main characteristics of the invention are a seat tube, a fixing base, a seat post, a movable block, two bolts, plural plastic ornamental sleeves and a twinkling light. The seat tube is shaped as a water drop in its cross-sectional view. The fixing base shaped the same as the seat tube is to be fitted in and welded with the seat tube and provided with a tube hole and a sliding slot in communication with the tube hole. The movable block is screwed with two bolts able to keep the movable block suspended and moved back and forth, enabling the movable block to loosen or squeeze the seat post.

### BRIEF DESCRIPTION OF DRAWINGS

This invention is better understood by referring to the accompanying drawings, wherein:

FIG. 1 is an exploded perspective view of a preferred embodiment of a height adjusting device for a bike seat in the present invention;

FIG. 2 is a perspective view of the preferred embodiment of a height-adjusting device for a bike seat in the present invention, showing relative positions of all components;

FIG. 3 is an exploded perspective view of plural plastic ornamental sleeves in the present invention; and

FIG. 4 is a perspective view of the plural plastic ornamental sleeves in the present invention.

### DETAILED DESCRIPTION OF THE PREFERRED EMBODIMENT

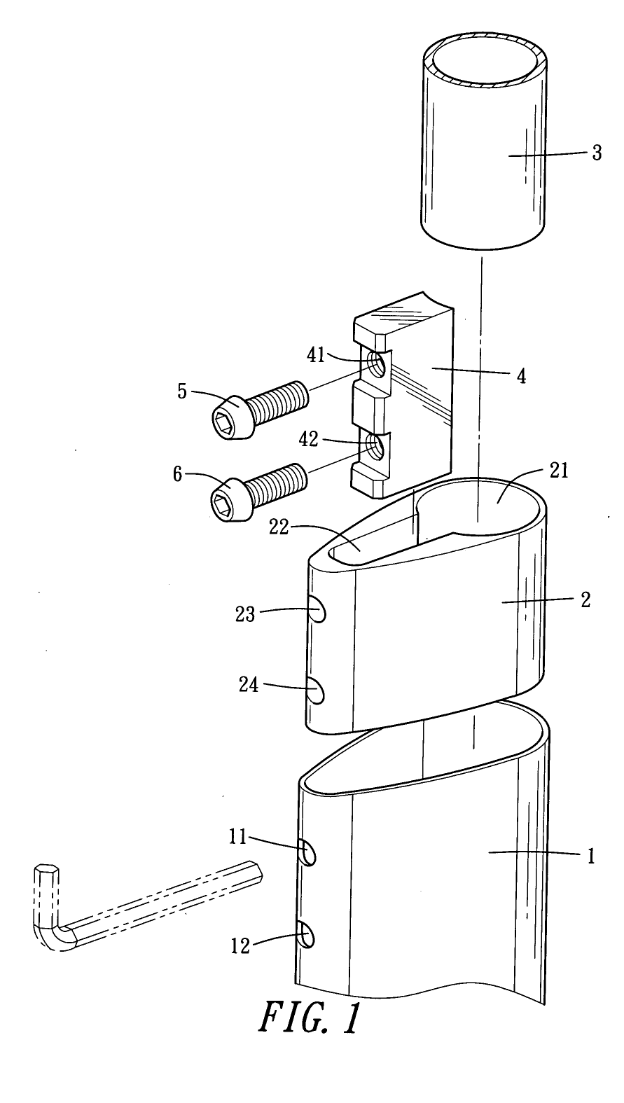

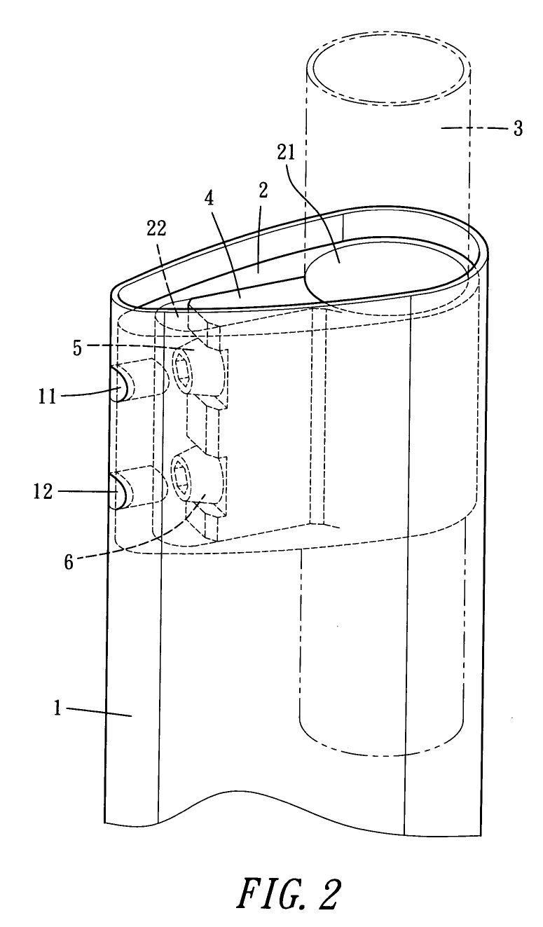

As shown in FIGS. 1 and 2, a preferred embodiment of a height adjusting device for a bike seat in the present invention includes a seat tube 1, a fixing base 2, a seat post 3, a movable block 4, two bolts 5 and 6, plural plastic ornamental sleeves 71, 72, 73, 74 and a twinkling light 8.

The seat tube 1 is shaped as a water drop in its cross-sectional view and bored with two holes 11 and 12 at the tapered side.

The fixing base 2 is shaped the same as the seat tube 1 and to be fitted in and welded with the seat tube 1. The fixing base 2 is provided with a vertical tube hole 21 for the seat post 3 to fit therein and a sliding slot 22 in communication with the tube hole 21. In addition, two holes 23 and 24 are bored in a wall behind the sliding slot 22 to communicate with the sliding slot 22.

The movable block 4 to be fitted in the sliding slot 22 is bored with two sidewise nut holes 41 and 42 that are matched respectively with the holes 23 and 24 of the fixing base 2 and the holes 11 and 12 of the seat tube 1, enabling the bolts 5 and 6 to respectively pass through the holes 23 and 24 to screw together with the nut holes 41 and 42, keeping the movable block 4 suspended. In addition, the side surface of the movable block 4 facing to the seat post 3 is provided with anti-slipping texture.

The bolts 5 and 6 are respectively put through the holes 11 and 12 and the holes 23 and 24 orderly to screw with the nut holes 41 and 42.

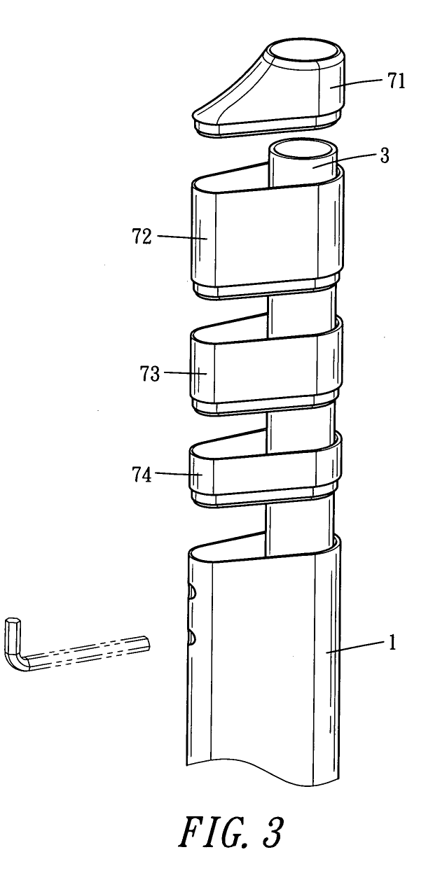

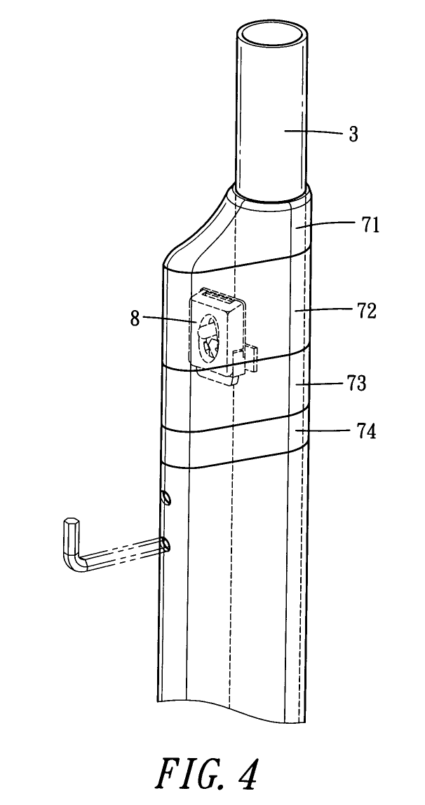

In using, a screw driver or the like can pass through the holes 11 and 12 to rotate the bolts 5 and 6 clockwise or counterclockwise, so that the movable block 4 can be pulled back for adjusting the height of the seat post 3 and pushed forwards to squeeze the seat post 3 for keeping it positioned therein. As shown in FIGS. 3 and 4, the plastic ornamental sleeves 71, 72, 73, 74 can be combined randomly depending on the height of the seat post 3 and worn around the seat post 3. Further, the twinkling light 8 based on a LED light and powered by a square battery is installed inside the plastic ornamental sleeve 72 facing to the back of a bike for showing warning at night.

While the preferred embodiment of the invention has been described above, it will be recognized and understood that various modifications may be made therein and the appended claims are intended to cover all such modifications that may fall within the spirit and scope of the invention.

What is claimed is:

1. A height-adjusting device for a bike seat comprising:
a seat tube shaped as a water drop in the cross-sectional view and bored with two holes at a tapered side;
a fixing base shaped the same as said seat tube, fitted in and welded with said seat tube, having an axial tube hole and a sliding slot communicating with said tube hole and bored with two sidewise holes in a tapered side corresponding to said holes of said seat tube;
a seat post supporting a bike's seat;
a movable block to be fitted in said sliding slot and bored with two sidewise nut holes 41 and 42 corresponding to said holes of said seat post; and
two bolts able to pass through said holes of said seat tube and said holes of said fixing base to screw in said nut holes of said movable block to keep said fixing base suspended and move back and forth laterally so as to relax or squeeze said seat post.

2. A height adjusting device for a bike seat as claimed in claim 1, wherein said movable block is provided with an anti-slipping texture on the side surface facing to said seat post.

3. A height adjusting device for a bike seat as claimed in claim 1, wherein said seat post is fitted around with a random combination of four plastic ornamental sleeves.

4. A height adjusting device for a bike seat as claimed in claim 1, wherein a twinkling light is installed in one of said plastic ornamenting sleeves, facing to the back of a bike.
